(19) United States
(12) Patent Application Publication
(10) Pub. No.: US 2026/0053697 A1
(43) Pub. Date: Feb. 26, 2026

(54) HEAD-WORN SEXUAL MASSAGER

(71) Applicants: Dongguan Mimao Electronic Technology Co., Ltd., Dongguan (CN); Dongguan Yueya Technology Co., Ltd., Dongguan (CN)

(72) Inventor: Dongjun Wu, Dongguan (CN)

(21) Appl. No.: 19/087,576

(22) Filed: Mar. 23, 2025

(30) Foreign Application Priority Data
Aug. 26, 2024 (CN) 202422082847.0

(51) Int. Cl. A61H 19/00

(52) U.S. Cl. CPC A61H 19/44; A61H 19/50; A61H 2201/1215; A61H 2201/123; A61H 2201/1607

(57) ABSTRACT

A head-worn sexual massager includes a massage portion and a positioning portion which are connected to each other. The massage portion includes a shell and a driving mechanism. The shell has a connecting end and a massage section connected to the connecting end, and the connecting end is connected to the positioning portion. The driving mechanism is mounted inside the shell and configured to drive the massage section to move. The positioning portion has at least one loop configured to be secured onto a human head.

### CROSS-REFERENCE TO RELATED APPLICATIONS

The present disclosure claims priority of Chinese Patent Application No. 202422082847.0, filed on Aug. 26, 2024, the entire contents of which are hereby incorporated by reference.

### TECHNICAL FIELD

The present disclosure relates to the technical field of sexual massage devices, and in particular to a head-worn sexual massager.

### BACKGROUND

With the continuous development of society, sexual massage devices have become increasingly popular, reflecting the growing attention to sexual health and personal pleasure. Modern individuals are increasingly aware of the importance of sex education and are willing to enhance their sexual experience and promote intimacy between partners through the use of sexual massage devices. However, typical sexual massage devices require users to hold and operate, which in use result in inconvenience during sexual intercourse of couples.

### SUMMARY

The main objective of the present disclosure is to provide a head-worn sexual massager to solve the problem existing in the prior art.

In some embodiments, the present disclosure provides a head-worn sexual massager including a massage portion and a positioning portion which are connected to each other,
the massage portion includes:
a shell having a connecting end and a massage section connected to the connecting end, and the connecting end being connected to the positioning portion; and
a driving mechanism mounted inside the shell and configured to drive the massage section to move,
the positioning portion has at least one loop configured to be secured onto a human head.

In some embodiments, the massage portion is in a shape of an elongated rod.

In some embodiments, the massage portion further includes a vibration motor provided inside the shell.

In some embodiments, the positioning portion includes a connecting section connected to the shell of the massage portion, and a surface of the connecting section facing an interior of the at least one loop is a concave surface.

In some embodiments, the concave surface is a concave curved surface.

In some embodiments, the connecting section includes a middle portion connected to the shell of the massage portion, at least one first wing portion and at least one second wing portion; and
the at least one first wing portion and the at least one second wing portion extend from the middle portion towards two different sides of the middle portion respectively, and the at least one first wing portion, the middle portion and the at least one second wing portion together form the concave surface.

In some embodiments, the shell includes a rigid inner shell and a soft outer shell covering an outer periphery of the rigid inner shell, and the driving mechanism is located inside the rigid inner shell and configured to drive the massage section to perform at least one of swinging, extending and retracting, vibrating and twisting.

In some embodiments, the driving mechanism is configured to drive the massage section to swing,
the driving mechanism includes a motor mounted in the rigid inner shell, a driving ball connected to the motor, and a stimulation component provided inside the soft outer shell and spaced from the rigid inner shell;
an output shaft of the motor includes a first shaft section and a second shaft section which are arranged one after another in a direction facing distally, the first shaft section is coaxial with an axial axis of the motor, and the second shaft section is arranged at an angle with respect to the first shaft section; and
the stimulation component is hinged to the rigid inner shell, the stimulation component has a receiving chamber which extends along a first direction and is perpendicular to the first shaft section, and the driving ball is fixedly mounted on the second shaft section and accommodated inside the receiving chamber.

In some embodiments, the receiving chamber is further provided with a sliding slot which extends along the first direction, the second shaft section is inserted the receiving chamber through the sliding slot, and the driving ball is slidably accommodated in the receiving chamber.

In some embodiments, the driving mechanism is configured to drive the massage section to extend and retract,
the driving mechanism includes a motor, a rotating shaft, and a sliding sleeve; and
the rotating shaft is connected to an output shaft of the motor, the sliding sleeve is mounted around and cooperated with an outer periphery of the rotating shaft, and when the rotating shaft rotates, the sliding sleeve is driven to reciprocate linearly in an axial direction of the rotating shaft to drive the massage section to extend and retract.

In some embodiments, the sliding sleeve includes a guide member and a sliding cylinder which are fixedly connected, the outer periphery of the rotating shaft is provided with a guide groove, and the guide member cooperates with the guide groove to convert rotating of the rotating shaft into axially reciprocating of the sliding cylinder.

In some embodiments, the guide groove includes a first helical groove segment and a second helical groove segment,
the first helical groove segment extends from a first terminal at a first end of the rotating shaft to a second terminal at a second end of the rotating shaft in a clockwise direction, and the second helical groove segment extends from the first terminal at the first end of the rotating shaft to the second terminal at the second end of the rotating shaft in a counterclockwise direction, and
one end of the first helical groove segment is connected to one end of the second helical groove segment at the first terminal, and an other end of the first helical groove segment is connected to an other end of the second helical groove segment at the second terminal.

In some embodiments, the driving mechanism is configured to drive the massage section to vibrate, and the driving mechanism includes a vibration motor arranged inside the rigid inner shell.

In some embodiments, the driving mechanism is configured to drive the massage section to twist,
the driving mechanism includes a motor mounted in the rigid inner shell, a driving ball connected to the motor and a stimulation component provided inside the soft outer shell and spaced from the rigid inner shell, the driving ball is connected to a free end of an output shaft of the motor, and the driving ball is cooperated with the stimulation component to make the massage section twist.

In some embodiments, the output shaft of the motor includes a first shaft section and a second shaft section that are arranged one after another in a direction facing distally, the first shaft section is coaxial with the motor, the second shaft section is arranged at an angle with respect to the first shaft section, and the driving ball is fixedly mounted on the second shaft section and accommodated inside the stimulation component.

In some embodiments, the stimulation component has a receiving chamber and a through hole, the through hole is configured for the second shaft section to pass through, and the receiving chamber is in interference fit with the driving ball.

In some embodiments, the present disclosure provides a head-worn sexual massager, including:
a massage portion having an electrically driven stimulation component; and
a positioning portion configured to be secured onto a human head, the positioning portion is connected to the massage portion at a middle portion,
the positioning portion includes at least one first wing and at least one second wing that extend towards two opposed sides from the middle portion.

In some embodiments, the at least one first wing and the at least one second wing are connected to form a loop.

In some embodiments, the at least one first wing and at least one second wing are connected through at least one flexible constraint member, and the at least one flexible constraint member is provided with a length-adjusting device.

In some embodiments, the massage portion is in a shape of an elongated rod, and a vibration motor is provided inside the massage portion.

When the head-worn sexual massager of the present disclosure is in use, the massage portion can be driven to move by the driving mechanism, so that the massage portion can extend into the human body channel and move to stimulate the inner wall of the human body channel. The positioning portion is fitted onto the human head, and the massager can be positioned without holding the head-worn sexual massager, thereby enhancing the convenience and stability of the head-worn sexual massager and freeing both hands.

### BRIEF DESCRIPTION OF THE DRAWINGS

FIG. 1 is a schematic structural view of a head-worn sexual massager according to one embodiment of the present disclosure;

FIG. 2 is an exploded view of the head-worn sexual massager according to one embodiment of the present disclosure;

FIG. 3 is an enlarge view of a portion A in FIG. 2.

FIG. 4 is a cross-sectional view of a part of a head-worn sexual massager according to a first embodiment of the present disclosure;

FIG. 5 is a schematic structural view of a part of the head-worn sexual massager according to the first embodiment of the present disclosure;

FIG. 6 is a schematic structural view of another part of the head-worn sexual massager according to the first embodiment of the present disclosure;

FIG. 7 is a cross-sectional view of a part of a head-worn sexual massager according to a second embodiment of the present disclosure;

FIG. 8a is a schematic structural view of a part of the head-worn sexual massager according to the second embodiment of the present disclosure;

FIG. 8b is an exploded view of the part in FIG. 8a.

FIG. 9 is a cross-sectional view of a part of a head-worn sexual massager according to a third embodiment of the present disclosure;

FIG. 10 is a cross-sectional view of a part of a head-worn sexual massager according to a fourth embodiment of the present disclosure; and

FIG. 11 is a schematic structural view of a part of the head-worn sexual massager according to the fourth embodiment of the present disclosure.

### DESCRIPTION OF THE EMBODIMENTS

In order to facilitate the understanding of the present disclosure, a more comprehensive description of the present disclosure will be made with reference to the relevant drawings below. The drawings provide one or more exemplary embodiments of this present disclosure, so that the technical solutions disclosed in this present disclosure can be more accurately and thoroughly understood. However, it should be understood that the present disclosure can be implemented in various different forms and is not limited to the embodiments described below.

In the drawings of this present disclosure, the same or similar reference numerals correspond to the same or similar components. In the description of this present disclosure, it should be understood that terms such as “up,” “down,” “left,” “right,” and other directional or positional relationships are based on the orientations or positional relationships shown in the drawings. These terms are merely used for ease of description and to simplify the explanation, and do not indicate or imply that the devices or components being referred to must have specific orientations or be constructed and operated in specific orientations. Therefore, the terminology describing positional relationships in the drawings is used only for illustrative purposes and should not be understood as limiting the present disclosure. The specific meanings of the above terms can be understood according to the context by those skilled in the art.

Additionally, if the description in this present disclosure includes terms such as “first,” “second,” etc., these terms are used for descriptive purposes only and should not be understood as indicating or implying their relative importance or the implied number of technical features being referred to. Therefore, features described as “first,” “second,” etc., can explicitly or implicitly include at least one instance of that feature. Moreover, the terms “and/or” used throughout this present disclosure are understood to include three possible scenarios: for example, “A and/or B” includes the A scenario, the B scenario, or a scenario in which both A and B are satisfied simultaneously.

Furthermore, the term “transmission connection” used in the present disclosure means that the components involved in the transmission connection can transfer power between each other. Therefore, the connection between the components involved in “transmission connection” can be either a direct connection or an indirect connection through additional transmission components.

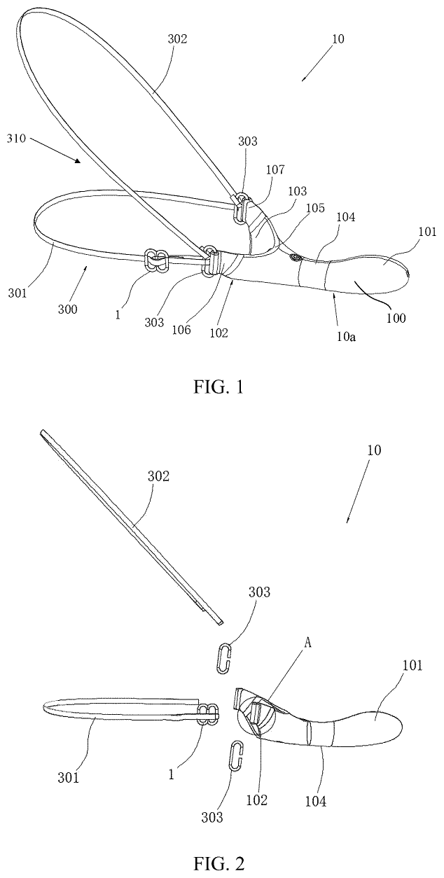

Referring to FIG. 1 and FIG. 4, a head-worn sexual massager 10 according to an embodiment of the present disclosure is shown. The head-worn sexual massager 10 includes a massage portion 10a and a positioning portion 300, which are connected to each other.

The massage portion 10a includes a shell 100 and a driving mechanism 200. The shell 100 has a connecting end 104 and a massage section 101 connected to the connecting end 104. The connecting end 104 is connected to the positioning portion 300. The massage portion 10a is in a shape of an elongated rod. The massage portion 10a further includes a vibration motor provided inside the shell 100.

The shell 100 includes a first end serves as the massage section 101, and a second end located away from the first end serves as the connecting end 104. The massage section 101 is used for inserting into a human channel (e.g., vagina, anus, etc.) to stimulate sensitive sexual areas of the body.

The driving mechanism 200 is mounted inside the shell 100 and configured to drive the massage section 101 to move, stimulating the interior walls or skin of the human channel through its motion.

The positioning portion 300 has at least one loop 310 configured to be secured onto a human head. The positioning portion 300 includes a connecting section 102 connected to the shell 100 of the massage portion 10a. Specifically, the connecting section 102 is connected to the connecting end 104 of the shell 100.

In use, the massage section 101 may be driven to move through the driving mechanism 200, allowing the massage section 101 to stimulate the interior walls or skin of the user after the massage device have been inserted into the channel of the user. Meanwhile, the positioning portion 300 is worn on the human head. In this way, the head-worn sexual massager 10 can be positioned with no need to hold it manually, improving its usability and stability, and achieving hands free.

Referring to FIG. 1, in an embodiment of the present disclosure, a surface of the connecting section 102 facing an interior of the at least one loop 310 is a concave surface. This concave surface 103 can better conform the human face (especially the chin area) and increase the wrapping effect on the face, as such the head-worn sexual massager 10 can be mounted onto the human head more stably, which facilitates precise control of the device.

Further referring to FIG. 1, the concave surface 103 is a concave curved surface. This design enables the positioning portion 300 to better fit the human face.

Again referring to FIG. 1, in an embodiment of the present disclosure, the connecting section 102 is substantially Y-shaped, including a middle portion 105 connected to the shell 100 of the massage portion 10a, at least one first wing portion 106 and at least one second wing portion 107. The at least one first wing portion 106 and the at least one second wing portion 107 extend from the middle portion 105 towards opposite sides of the middle portion 105 respectively. The at least one first wing portion 106 and at least one second wing portion 107 extend in directions away from each other. The at least one first wing portion 106, the middle portion 105, and the at least one second wing portion 107 are connected to form the concave surface 103. The extending first wing portion 106 and second wing portion 107 facilitate the positioning portion 300 to be better compliant to the human face, increasing the reliability and stability when the positioning portion 300 fits onto the human head.

Specifically, the shell 100 is elongated and defines a longitudinal direction. A first end of the massage section 101 is a free end which may enter into the human channel. The connecting end 104 extends from a second end of the massage section 101 along the longitudinal direction. The connecting section 102 of the positioning portion 300 is connected to an end of the connecting end 104 away from the massage portion 101 in a longitudinal direction of the shell 100. The first wing portion 106 and the second wing portion 107 extend from the middle portion 105 each at an angle with the longitudinal direction, and the lengths that the first wing portion 106 and the second wing portion 107 extend should ensure that the dimensions of the connecting section 102 match the size of the human face more effectively.

In some embodiments, a head-worn sexual massager 10 includes a massage portion 10a having an electrically driven stimulation component 2, and a positioning portion 300 configured to be secured onto a human head. The positioning portion 300 is connected to the massage portion 10a at a middle portion 105.

The positioning portion 300 includes at least one first wing 106 and at least one second wing 107 that extend towards two opposed sides from the middle portion 105.

The at least one first wing 106 and the at least one second wing 107 are connected to form a loop 310 to fit onto the human head.

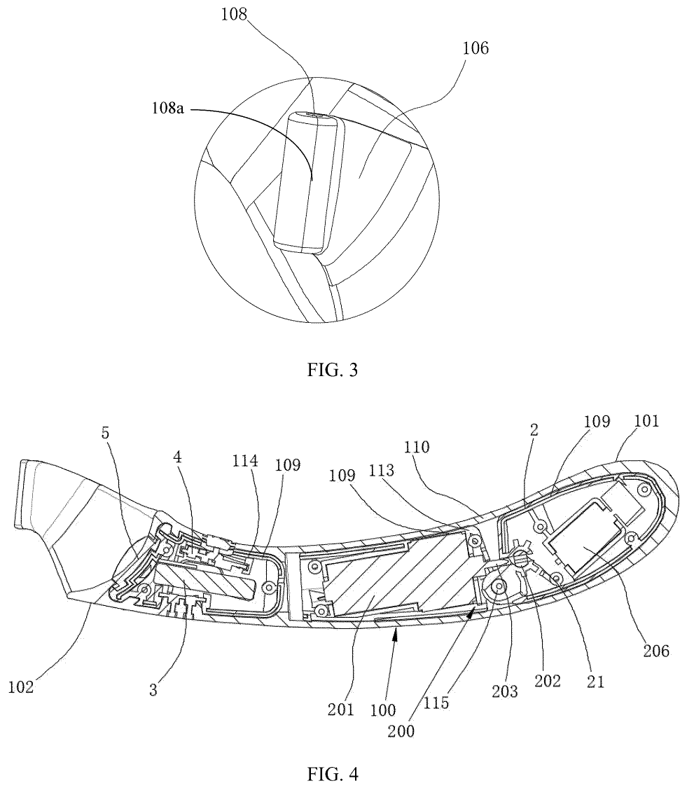

Referring to FIG. 1 to FIG. 3, according to an embodiment of the present disclosure, the at least one first wing 106 and the at least one second wing 107 are connected through at least one flexible constraint member. In an embodiment, there are two flexible constraint members provided. The at least one first wing 106 and at least one second wing 107 are connected through a first flexible constraint member 301 and a second flexible constraint member 302. The first flexible constraint member 301 and second flexible constraint member 302 are arranged at an angle relative to each other. By providing the two flexible constraint members, it allows positioning of the device at different points on the human head, ensuring the reliability, stability, and operability of the positioning portion 300 when fitted onto the human head.

Specifically, the positioning portion 300 may further include two open rings 303, i.e., unclosed rings. Each end of the first wing portion 106 and the second wing portion 107 away from the middle portion 105 is provided with a hollow tube 108a. Each hollow tube 108a has an insertion hole 108 with two open ends. The two open rings 303 are respectively engaged in the two hollow tubes 108a. Two ends of each open ring 303 are inserted into the two open ends of the corresponding insertion hole 108 of the first wing portion 106 or the second wing portion 107. Two ends of the first flexible constraint member 301 are connected to the open rings 303 that are connected to the first wing portion 106 and the second wing portion 107 respectively. Two ends of the second flexible constraint member 302 are also connected to the open rings 303 that are connected to the first wing portion 106 and the second wing portion 107 respectively.

According to embodiments of the present disclosure, the first flexible constraint member 301 may be arranged in the horizontal direction, used for fitting around the neck area of the human head. The second flexible constraint member 302 may extend inclinedly and upwardly in a direction away from the connecting section 102, and the rear end of the second flexible constraint member is capable of fitting around the back of the human head.

It should be understood that, the arrangement directions (orientations) of the first flexible constraint member 301 and second flexible constraint member 302 are not limited to the above-mentioned embodiments, and the positioning portion 300 is not limited to include only two flexible constraint members (i.e., the first flexible constraint member 301 and second flexible constraint member 302). The positioning portion 300 may also include exactly one flexible constraint member or three or more flexible constraint members. Further, the positioning portion 300 may be other types of components instead of flexible binding members, such as elements that help retaining onto the human head, and so on.

Referring to FIG. 1 and FIG. 2, according to an embodiment of the present disclosure, at least one of the first flexible constraint member 301 and second flexible constraint member 302 is equipped with a length-adjusting device 1. The size of the inner loop enclosed by the first flexible constraint member 301 and/or second flexible constraint member 302 with the connecting section 102 can be adjusted via the length-adjusting device 1. On one hand, this allows the device to fit different head sizes, and on the other hand, it can tighten the first flexible constraint member 301 or second flexible constraint member 302 to ensure they fit more securely around the human head when in cooperation with the connecting section 102.

According to another embodiment of the present disclosure, both the first flexible constraint member 301 and the second flexible constraint member 302 are flexible straps. The length-adjusting device 1 includes a hook-and-loop fastener, for example Velcro, which establish a secure connection through the interlocking of small hooks on a surface and fibers on a second surface, such that objects can be secured, connected or detached conveniently. The first flexible constraint member 301 and second flexible constraint member 302 are not limited to flexible straps but can also be structures such as ropes, strings, chains, etc.

Additionally, the length-adjusting device 1 may also be an adjustable buckle (similar to the adjustment buckle on backpack straps), or an adjustment means comprising a belt with a plurality of holes and a tongue that is engageable into one of the holes to position, like a trouser belt, to adjust the lengths of the first flexible constraint member 301 and second flexible constraint member 302.

Referring to FIG. 4, according to an embodiment of the present disclosure, the shell 100 includes a rigid inner shell 109 and a soft outer shell 110 covering an outer periphery of the rigid inner shell 109. The driving mechanism 200 is located inside the rigid inner shell 109. Specifically, the rigid inner shell 109 may be made of a rigid material such as hard plastic, while the soft outer shell 110 can be made of skin-friendly materials for example silicone. Since the soft outer shell 110 is the outermost layer of the head-worn sexual massager 10 that directly contacts the human body, especially during the massage process, it provides a soft touch with a cushioning effect when applied to the human channel, improving the comfort and experience of the massage.

According to a specific embodiment of the present disclosure, the driving mechanism 200 is used to drive the massage section 101 to perform at least one of the following movements relative to the main body: swinging, extending and retracting, vibrating, and twisting. In other words, the driving mechanism 200 can drive the massage section 101 to swing, extend and retract, vibrate, twist, or any combination of these four movements. In this present disclosure, “swinging” refers to the massage portion swinging around a base or pivot point; “twisting” refers to the massage portion being angled relative to an axis and rotating in one direction around that axis; and “extending and retracting” refers to the massage portion extending and retracting along its longitudinal back-and-forth.

Referring to FIG. 4 to FIG. 6, according to a first embodiment of the present disclosure, the driving mechanism 200 is used to drive the massage section 101 to swing. The driving mechanism 200 includes a motor 201 mounted in the rigid inner shell 109, a driving ball 202 connected to the motor 201 and a stimulation component 2 provided inside the soft outer shell 110 and spaced from the rigid inner shell 109. The stimulation component extends inside the massage section 101. The stimulation component 2 is a swingable relative to the rigid inner shell 109. The stimulation component 2 can be hinged to the rigid inner shell 109 via a hinge rod 115, for example, hinged to a motor fixing shell 113 of the rigid inner shell 109. The motor fixing shell 113 is provided with the hinge rod 115, and the stimulation component 2 is equipped with a rod sleeve 115a that is mounted around the hinge rod 115. The rod sleeve 115a may rotate relative to the hinge rod 115, allowing the stimulation component 2 to rotate relative to the hinge rod 115, i.e., relative to the motor fixing shell 113.

An output shaft 203 of the motor 201 includes a first shaft section 204 and a second shaft section 205 arranged one after another in a direction facing distally. The first shaft section 204 is coaxial with the axial axis of the motor 201, and the second shaft section 205 is arranged at an angle with respect to the first shaft section 204. The driving ball 202 is fixed on the second shaft section 205.

The stimulation component 2 has a receiving chamber 21 extending along a first direction (indicated by arrow “R1” in the figure) perpendicular to the first shaft section 204. The receiving chamber 21 is also provided with a sliding slot 21a penetrating through its lateral wall. The second shaft section 205 is inserted into the receiving chamber 21 through the sliding slot 21a. The driving ball 202 is slidably accommodated in the receiving chamber 21. In this embodiment, the receiving chamber 21 is in the tubular shape.

When the motor 201 operates, the output shaft 203 rotates around the axial axis of the first shaft section 204, and the driving ball 202 rotates along with the second shaft section 205, in a plane perpendicular to the first shaft section 204.

The movement of the driving ball 202 at each position can be considered as a combination of a first motion along the first direction and a second motion along the second direction perpendicular to the first direction (indicated by arrow “R2” in the figure) in the plane. Because the receiving chamber 21 extends along the first direction, the movement of the driving ball 202 along the first direction makes its sliding within the receiving chamber 21, which will not cause the stimulation component 2 to move in the first direction when the output shaft 203 rotates. In this way, the stimulation component 2 does not swing along the first direction, but only swings along the second direction.

The amplitude of the swing motion of the stimulation component 2 may be determined by the included angle between the second shaft section 205 and the first shaft section 204. Specifically, the larger the angle between the second shaft section 205 and the first shaft section 204, the larger the amplitude of the swing of the stimulation component 2.

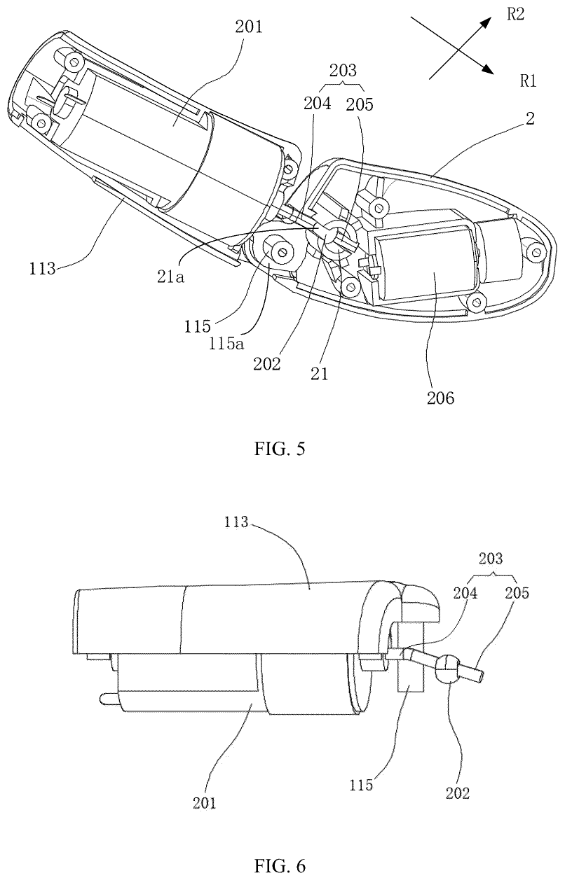

Referring to FIG. 4 and FIG. 5, additionally, a vibration motor 206 may be provided and installed in the stimulation component 2, allowing the massage section 101 to simultaneously perform swinging and vibration.

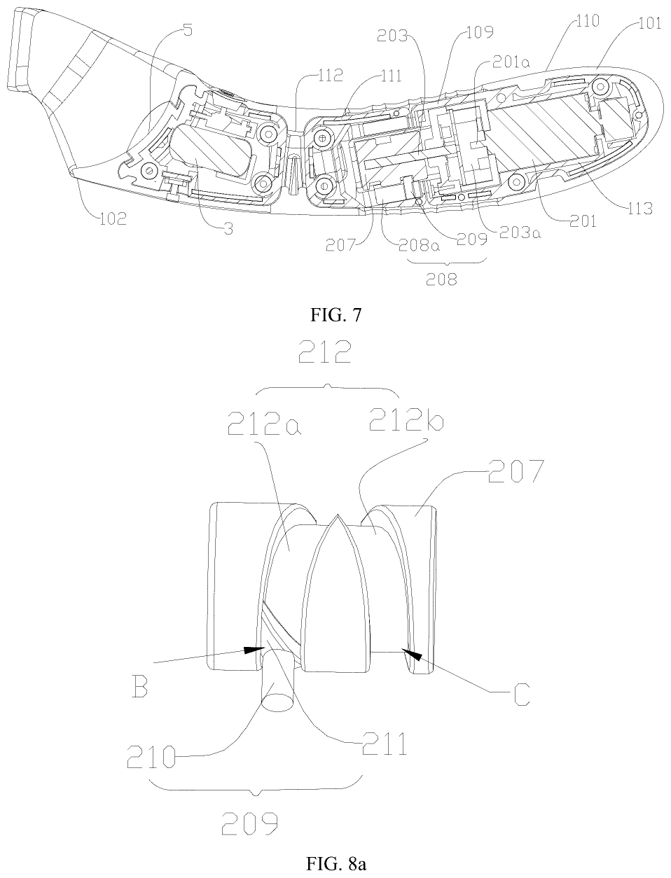

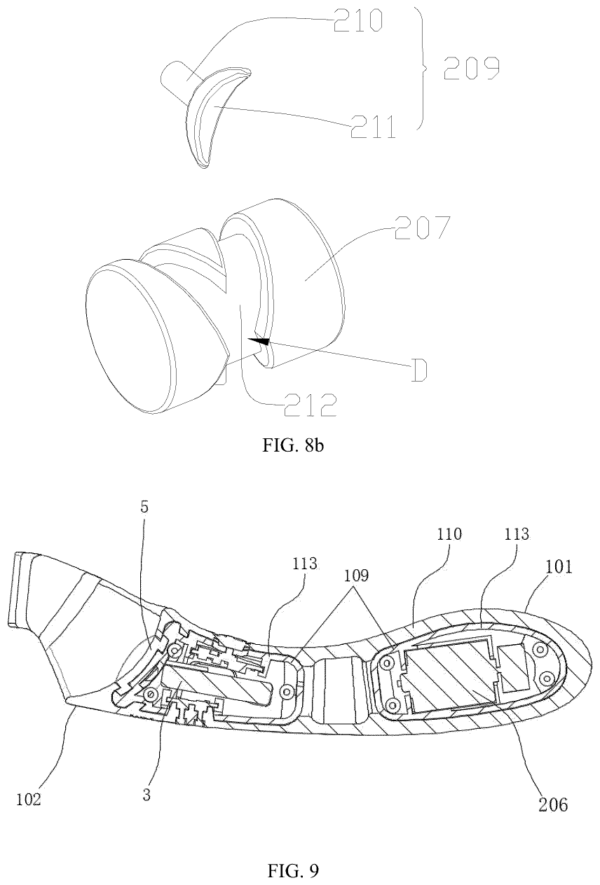

Referring to FIG. 7, FIG. 8a, and FIG. 8b, according to a second embodiment of the present disclosure, the driving mechanism 200 is used to drive the massage section 101 to perform extension and retraction motion relative to the connecting end 104. The driving mechanism 200 includes a motor 201, a rotating shaft 207, and a sliding sleeve 208. The rotating shaft 207 is in torque-proof connection with the output shaft 203 of the motor 201, and the sliding sleeve 208 is mounted around and cooperated with the outer periphery of the rotating shaft 207. The output shaft 203 is in torque-proof connection with the motor shaft 201a of the motor 201 through a coupling device 203a. When the rotating shaft 207 rotates, the sliding sleeve 208 is driven to move linearly in the axial direction of the rotating shaft 207. The relative motion of the sliding sleeve 208 and the motor 201 can drive the massage section 101 to perform telescopic motion.

As an embodiment, the sliding sleeve 208 includes a guide member 209 and a sliding cylinder 208a that are fixedly connected. The guide member 209 protrudes inwardly beyond an inner periphery of the sliding cylinder 208a. The outer periphery of the rotating shaft 207 is provided with a guide groove 212 extending inclinedly. The sliding cylinder 208a is mounted around the outer periphery of the rotating shaft 207, with the guide member 209 being engaged with the guide groove 212.

Preferably, the guide member 209 includes a connecting post 210 fixedly connected to the sliding cylinder 208a, and a guide block 211 connected to a distal end of the connecting post 210. The guide block 211 is engaged with the guide groove 212 on the rotating shaft 207.

The guide groove 212 includes a first helical groove segment 212a and a second helical groove segment 212b. The first helical groove segment 212a extends from a first terminal B at the first end of the rotating shaft 207 to a second terminal C at the second end of the rotating shaft 207 in a clockwise direction. The second helical groove segment 212b extends from the first terminal B at the first end of the rotating shaft 207 to the second terminal C at the second end of the rotating shaft 207 in a counterclockwise direction. Each of the first helical groove segment 212a and the second helical groove segment 212b spans 360°, i.e., one circle, around the periphery of the rotating shaft 207. That is, a line connecting the first terminal B at the first end and the second terminal C at the second end on the periphery of the rotating shaft 207 forms a generatrix of the rotating shaft 207.

Furthermore, the first helical groove segment 212a and the second helical groove segment 212b intersect at the point D between the first end and the second end of the rotating shaft 207. The first end of the first helical groove segment 212a and the first end of the second helical groove segment 212b are connected at the first terminal B, and this connection is preferably a smooth transition; the second end of the first helical groove segment 212a and the second end of the second helical groove segment 212b are connected at the second terminal C, and this connection is also preferably a smooth transition.

When the rotating shaft 207 rotates, the guide member 209, specifically the guide block 211, moves along the first helical groove segment 212a, from the first terminal B at the first end of the rotating shaft 207 to the second terminal C at the second end of the rotating shaft 207 in a clockwise direction. After that, as the rotating shaft 207 continues to rotate, the guide block 211 continues to move, enters into the second helical groove segment 212b and moves there along, from the second terminal C at the second end of the rotating shaft 207 to the first terminal B at the first end of the rotating shaft 207 in a clockwise direction, thereby completing a continuous cycle.

Alternatively, when the rotating shaft 207 rotates, the guide block 211 may move along the second helical groove segment 212b, from the first terminal B at the first end of the rotating shaft 207 to the second terminal C at the second end of the rotating shaft 207 in a counterclockwise direction. After that, as the rotating shaft 207 continues to rotate, the guide block 211 continues to move, enters into the first helical groove segment 212a and moves there along, from the second terminal C at the second end of the rotating shaft 207 to the first terminal B at the first end of the rotating shaft 207 in a counterclockwise direction, thereby completing a continuous cycle.

When the rotating shaft 207 rotates, the guide block 211 is urged by the walls defining the guide groove 212 to move along the axis of the rotating shaft 207 back-and-forth linearly between the first end to the second end, this in turn drives the sliding sleeve 208 to move back and forth along the axis of the rotating shaft 207. The guide block 211 is preferably curved, for example, an arcuate plate, that matches the outer circumferential surface of the rotating shaft 207, ensuring it is effectively constrained within the inclined guide groove 212. In this embodiment, the guide block 211 is crescent shaped with a concave curved contact surface.

In addition, the rigid inner shell 109 may include a telescoping shell 111, and the sliding sleeve 208 is fixed on the inner side of the telescoping shell 111. The telescoping shell 111 is abutted against a step 112 on the inside of the soft outer shell 110, allowing the soft outer shell 110 to be extended in the third direction. In this way, when the sliding sleeve 208 moves in the fourth direction opposite to the third direction, the soft outer shell 110 is retracted due to its inherent flexibility (elasticity), thereby achieving the telescopic motion of the massage section 101. The rigid inner shell 109 can also include a motor fixing shell 113, with the motor 201 installed inside the motor fixing shell 113.

Additionally, the rotating shaft 207 and the sliding sleeve 208 may be replaced with any other suitable mechanisms (structures) that can convert rotational motion into linear motion.

Referring to FIG. 9, according to a third embodiment of the present disclosure, the driving mechanism 200 is used to drive the massage section 101 to vibrate. The driving mechanism 200 includes a vibration motor 206 arranged inside the massage section 101, which drives the massage section 101 to vibrate. Specifically, the rigid inner shell 109 includes a motor fixing shell 113, and the vibration motor 206 is installed inside the motor fixing shell 113.

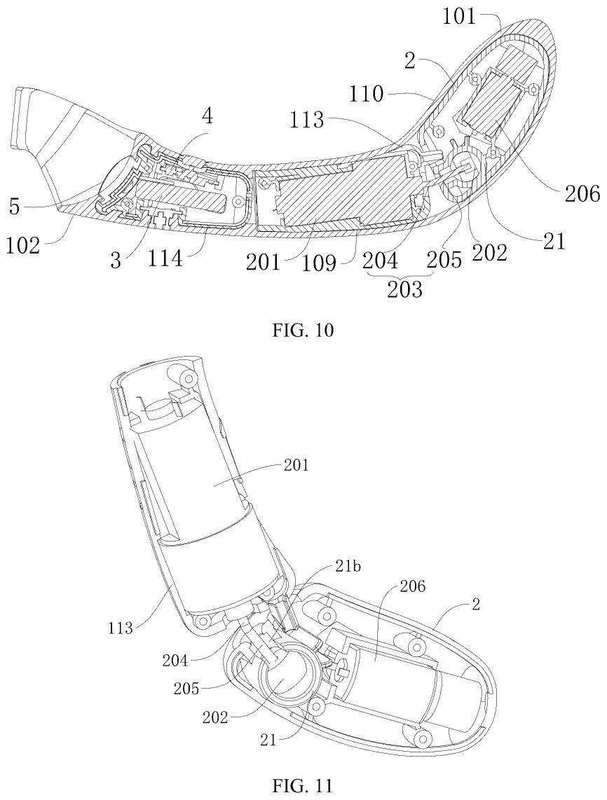

Referring to FIG. 10 and FIG. 11, according to a fourth embodiment of the present disclosure, the driving mechanism 200 is used to drive the massage section 101 to twist relative to the connecting end 104. The driving mechanism 200 includes a motor 201 mounted in the rigid inner shell, a driving ball 202 connected to the motor 201 and a stimulation component 2 provided inside the soft outer shell 110 and spaced from the rigid inner shell 109. The stimulation component extends inside the massage section 101. The output shaft 203 of the motor 201 includes a first shaft section 204 and a second shaft section 205 arranged one after another in a direction facing distally. The first shaft section 204 is coaxial with the motor 201, and the second shaft section 205 is arranged at an angle with respect to the first shaft section 204.

The stimulation component 2 is positioned inside the soft outer shell 110. The stimulation component 2 is provided with a receiving chamber 21, and the driving ball 202 is installed on the second shaft section 205 and is accommodated within the receiving chamber 21. The receiving chamber 21 also has a through hole 21b through which the second shaft section 205 passes. The size and shape of the through hole 21b are adapted to a cross section of the second shaft section 205. The driving ball 202 is accommodated in the receiving chamber 21. In this embodiment, the cross-sectional dimension of the receiving chamber 21 are adapted to the cross-sectional dimension of the driving ball 202.

Preferably, the driving ball 202 is in interference fit with the receiving chamber 21, with an amount of interference determined according to the actual situation. When the motor 201 operates, the output shaft 203 rotates about the axial axis of the first shaft section 204, and the driving ball 202 rotates with the second shaft section 205. Since the receiving chamber 21 and the driving ball 202 are in interference fit, the driving ball 202 drives the receiving chamber 21 to rotate, thereby driving the stimulation component 2 to rotate together.

Because the second shaft section 205 is arranged at an angle with respect to the first shaft section 204, the rotation of the motor 201 causes the second shaft section 205 to rotate around the first shaft section 204, such that the driving ball 202 drives the stimulation component 2 to rotate around the first shaft section 204.

Specifically, the larger the angle between the second shaft section 205 and the first shaft section 204, the greater the twisting amplitude of the stimulation component 2.

Additionally, a vibration motor 206 may be provided and installed on the stimulation component 2, so that the massage section 101 can achieve both twisting and vibrating simultaneously.

Referring to FIG. 4, in addition, the rigid inner shell 109 may also include a housing 114 for accommodating components such as the battery 3 and the circuit board 4 of the head-worn sexual massager 10. A detachable sealing cover 5 may be installed at the opening, making it easier to repair or replace the components inside the housing 114. Considering that the side of the sealing cover away from the housing 114 will contact the human face, a flexible material layer, such as a rubber layer or a silicone layer, may be provided on the side of the sealing cover away from the housing 114 to cushion the motion transmitted to the face.

The above embodiments are merely descriptions of the optional embodiments of the present disclosure and do not limit the scope of the present disclosure. Various modifications and improvements made by those skilled in the art to the technical solutions of the present disclosure without departing from the spirit of the design of the present disclosure should fall within the protection scope defined by the claims of the present disclosure.

1. A head-worn sexual massager, comprising a massage portion and a positioning portion which are connected to each other,
wherein the massage portion comprises:
a shell having a connecting end and a massage section connected to the connecting end, and the connecting end being connected to the positioning portion; and
a driving mechanism mounted inside the shell and configured to drive the massage section to move,
wherein the positioning portion has at least one loop configured to be secured onto a human head, and
wherein the shell comprises a rigid inner shell and a soft outer shell covering an outer periphery of the rigid inner shell, the rigid inner shell comprises a first shell and a second shell, the driving mechanism comprises a motor fixedly installed inside the first shell and an output end connecting the motor with the second shell in a torque transmission manner to cause relative movement between the first shell and the second shell when the motor operates.

2. The head-worn sexual massager according to claim 1, wherein the massage portion is in a shape of an elongated rod.

3. The head-worn sexual massager according to claim 1, wherein the massage portion further comprises a vibration motor provided inside the shell.

4. The head-worn sexual massager according to claim 1, wherein the positioning portion comprises a connecting section connected to the shell of the massage portion, and a surface of the connecting section facing an interior of the at least one loop is a concave surface.

5. The head-worn sexual massager according to claim 4, wherein the concave surface is a concave curved surface.

6. The head-worn sexual massager according to claim 4, wherein the connecting section comprises a middle portion connected to the shell of the massage portion, at least one first wing portion and at least one second wing portion; and
wherein the at least one first wing portion and the at least one second wing portion extend from the middle portion towards two different sides of the middle portion respectively, and the at least one first wing portion, the middle portion and the at least one second wing portion together form the concave surface.

7. (canceled)

8. The head-worn sexual massager according to claim 1, wherein the driving mechanism is configured to drive the massage section to swing,
wherein the driving mechanism comprises the motor mounted in the first shell, and a driving ball connected to the motor, and the second shell is provided inside the soft outer shell and spaced from the first shell;
wherein an output shaft of the motor comprises a first shaft section and a second shaft section which are arranged one after another in a direction facing distally, the first shaft section is coaxial with an axial axis of the motor, and the second shaft section is arranged at an angle with respect to the first shaft section; and
wherein the second shell is hinged to the first shell, the second shell has a receiving chamber which extends along a first direction and is perpendicular to the first shaft section, and the driving ball is fixedly mounted on the second shaft section and accommodated inside the receiving chamber.

9. The head-worn sexual massager according to claim 8, wherein the receiving chamber is further provided with a sliding slot which extends along the first direction, the second shaft section is inserted into the receiving chamber through the sliding slot, and the driving ball is slidably accommodated in the receiving chamber.

10. The head-worn sexual massager according to claim 1, wherein the driving mechanism is configured to drive the massage section to extend and retract,
wherein the driving mechanism comprises the motor, a rotating shaft, and a sliding sleeve; and
wherein the rotating shaft is connected to an output shaft of the motor, the sliding sleeve fixed on an inner side of the second shell surrounds and cooperates with an outer periphery of the rotating shaft, and when the rotating shaft rotates, relative linear movement is caused between the sliding sleeve and the rotating shaft in an axial direction of the rotating shaft to cause relative linear movement between the first shell and the second shell, so as to drive the massage section to extend and retract.

11. The head-worn sexual massager according to claim 10, wherein the sliding sleeve comprises a guide member and a sliding cylinder which are fixedly connected, the outer periphery of the rotating shaft is provided with a guide groove, and the guide member cooperates with the guide groove to convert rotating of the rotating shaft into axially reciprocating of the sliding cylinder relative to the rotating shaft.

12. The head-worn sexual massager according to claim 11, wherein the guide groove comprises a first helical groove segment and a second helical groove segment,
wherein the first helical groove segment extends from a first terminal at a first end of the rotating shaft to a second terminal at a second end of the rotating shaft in a clockwise direction, and the second helical groove segment extends from the first terminal at the first end of the rotating shaft to the second terminal at the second end of the rotating shaft in a counterclockwise direction, and
wherein one end of the first helical groove segment is connected to one end of the second helical groove segment at the first terminal, and an other end of the first helical groove segment is connected to an other end of the second helical groove segment at the second terminal.

13. (canceled)

14. The head-worn sexual massager according to claim 1, wherein the driving mechanism is configured to drive the massage section to twist,
wherein the driving mechanism comprises the motor mounted in the first shell, and a driving ball connected to the motor, component the second shell is provided inside the soft outer shell and spaced from the first shell, the driving ball is connected to a free end of an output shaft of the motor, and the driving ball is cooperated with the second shell to make the massage section twist.

15. The head-worn sexual massager according to claim 14, wherein the output shaft of the motor comprises a first shaft section and a second shaft section that are arranged one after another in a direction facing distally, the first shaft section is coaxial with the motor, the second shaft section is arranged at an angle with respect to the first shaft section, and the driving ball is fixedly mounted on the second shaft section and accommodated inside the second shell.

16. The head-worn sexual massager according to claim 15, wherein the second shell has a receiving chamber and a through hole, the through hole is configured for the second shaft section to pass through, and the receiving chamber is in interference fit with the driving ball.

17-20. (canceled)

21. The head-worn sexual massager according to claim 1, wherein the positioning portion comprises a flexible constraint member and a length-adjusting device, the flexible constraint member is configured to be worn onto the human head, and the length-adjusting device is provided on the flexible constraint member; and
wherein the flexible constraint member has a length measured in a circumference direction of the loop, and the length of the flexible constraint member and thus a size of the loop is adjustable by the length-adjusting device.

22. The head-worn sexual massager according to claim 1, wherein the driving mechanism is configured to drive the massage section to extend and retract,
wherein the driving mechanism comprises the motor, a rotating shaft, and a sliding sleeve; and
wherein the motor is configured to drive the sliding sleeve to move linearly relative to the rotating shaft with a single degree of freedom.

23. The head-worn sexual massager according to claim 6, wherein the at least one first wing portion and the at least one second wing portion are integrally connected with the soft outer shell.

24. The head-worn sexual massager according to claim 1, wherein the positioning portion further comprises a middle portion connected to the massage portion, at least one first wing portion and at least one second wing portion, and the soft outer shell extends from the middle portion towards two different sides of the middle portion respectively to form the at least one first wing portion and the at least one second wing portion; and
wherein each of the middle portion and the massage portion has a diameter of a cross section perpendicular to an axis of the massager, and the diameter of the middle portion is greater than the diameter of the massage portion.

25. The head-worn sexual massager according to claim 1, further comprising:
a battery and a circuit board mounted inside the shell and electrically connected to the driving mechanism,
wherein the rigid inner shell further comprises a third shell separate from the first shell and second shell, the third shell is located closer to the positioning portion than the first and second shell, and the battery and the circuit board are mounted within the third shell.

26. The head-worn sexual massager according to claim 25, wherein each of the first shell, the second shell and the third shell defines an accommodating space therein, and the accommodating spaces of the first shell, the second shell and the third shell are separate from each other.
